(19) United States
(12) Patent Application Publication
(10) Pub. No.: US 2025/0217689 A1
(43) Pub. Date: Jul. 3, 2025

(54) APPARATUS AND METHOD OF IMPROVED QUANTUM APPROXIMATE OPTIMIZATION ALGORITHM

(71) Applicant: Korea University Research and Business Foundation, Seoul (KR)

(72) Inventors: Jun HEO, Seoul (KR); Youngjin SEO, Seoul (KR)

(21) Appl. No.: 18/981,349

(22) Filed: Dec. 13, 2024

(30) Foreign Application Priority Data
Dec. 29, 2023 (KR) 10-2023-0196169

(51) Int. Cl. G06N 10/60

(52) U.S. Cl. CPC G06N 10/60

(57) ABSTRACT

The present disclosure relates to quantum approximate optimization technology, and more particularly, to an apparatus and method for an improved quantum approximate optimization algorithm. In one embodiment, the disclosure describes a method for implementing a quantum approximate optimization algorithm, which is performed by a processor of a quantum computing device.

### CROSS-REFERENCE TO RELATED APPLICATIONS

This application claims priority to and the benefit of Korean Patent Application No. 10-2023-0196169 filed in the Korean Intellectual Property Office on 29 Dec. 2023, the entire contents of which are incorporated herein by reference.

### TECHNICAL FIELD

The present disclosure relates to quantum approximate optimization technology, and more particularly, to an apparatus and a method of an improved quantum approximate optimization algorithm.

### BACKGROUND ART

A quantum computing device may be a computing device that processes data by using phenomena related to quantum mechanics such as quantum entanglement, quantum superposition, etc. The quantum entanglement may mean a state in which two or more states are quantumly connected to each other, so that they cannot be handled separately in each state. The quantum superposition may mean that various result states by measurement are simultaneously present probabilistically before measuring the quantum state. The quantum computing device can use a qubit as a basic unit of information for processing data by using a phenomenon related to the quantum mechanics.

The qubit may simultaneously express values corresponding to various bits by using the quantum superposition state. For example, the qubit may express respective values as probabilities such as ‘0 with a probability of 20% and 1 with a probability of 80%’. The qubit may be determined as one state while the quantum superposition state is released when being observed.

The quantum algorithm can be called a method for performing quantum computing, and can include a specific quantum circuit configuring method.

Among the quantum algorithms, as an algorithm of finding an approximate optimization solution, there is Quantum Approximate Optimization Algorithm (hereinafter, referred to as “QAOA”) first proposed by E. Farhi.

The QAOA can find the approximate optimization solution through quantum characteristics of a quantum state and an optimization algorithm in classical computing. The QAOA is a method in which a quantum circuit configuration scheme is simple, and as a result, there is an advantage.

A simple quantum circuit configuration advantage which the QAOA has can be an important part in a quantum computer operation in the age of Noisy Intermediate-Scale Quantum (hereinafter, referred to as “NISQ”). The NISQ age can mean an age in which the quantum computer is not completely developed, and as a result, a quantum computer in which noise cannot be completely modified, and the number of qubits which can be computed is limited is used.

The QAOA is a quantum algorithm in which a depth of a quantum circuit is small, but the number of iteration times should be increased in an iteration step of the QAOA in order to acquire a result having a high performance, so efficiency may deteriorate. Accordingly, research to solve this is continued.

### SUMMARY OF THE INVENTION

The present disclosure is contrived in response to the above-described background art, and has been made in an effort to provide an apparatus and a method of an improved quantum approximate optimization algorithm.

Technical objects of the present disclosure are not restricted to the technical object mentioned as above. Other unmentioned technical objects will be apparently appreciated by those skilled in the art by referencing the following description.

An exemplary embodiment of the present disclosure provides a method for implementing a quantum approximate optimization algorithm, which is performed by a processor of a quantum computing device, which may include: an initialization step of changing a plurality of qubits initialized into a superposition state by using a Hadamard gate; an operating step of performing an operation for each of the plurality of qubits which is in the superposition state by using a plurality of quantum operators set with a predetermined first angle parameter, wherein the plurality of quantum operators correspond to a cost function of a problem to be solved; a measurement step of acquiring a result value by performing a measurement for the plurality of qubits acquired as an operation performance result; an expected value calculation step of calculating an expected value by inputting the result value into a predetermined expected value algorithm; and an optimization step of calculating a second angle parameter different from a first angle parameter by inputting a predetermined first angle parameter and the expected value into a predetermined optimization algorithm.

Alternatively, the number of plurality of initialized qubits may correspond to a data size of the problem to be solved.

Alternatively, the operating step may include a problem Hamiltonian operating step of computing a plurality of quantum operators by transforming the cost function of the problem to the plurality of quantum operators, and adding a predetermined 1-1^{st} angle parameter to the plurality of quantum operators, a mixing Hamiltonian operating step of iteratively performing an operation for an Rₓ operator which rotates the plurality of qubits acquired as an operation result in the problem Hamiltonian operating step based on an X axis as large as the number of plurality of initialized qubits by using a predetermined 1-2^{nd} angle parameter, a recursion Hamiltonian operating step of performing the quantum operation for a predetermined specific operator by using a predetermined 1-3^{rd} angle parameter, and a recursion mixing Hamiltonian operating step of performing an operation for an Rₓ operator which rotates the plurality of qubits acquired as an operation result in the recursion Hamiltonian operating step based on the X axis by using a predetermined 1-4^{th} angle parameter.

Alternatively, the method may further include iteratively performing the recursion Hamiltonian operating step and the recursion mixing Hamiltonian operating step a predetermined number of times.

Alternatively, the method may further include a step of acquiring a plurality of result values by iterating the initialization step, the operating step, and the measurement step a predetermined number of iteration times after the measurement step, and the expected value calculation step may include an expected value calculation step of calculating the expected value by inputting the plurality of result values into the predetermined expected value algorithm.

Alternatively, the predetermined expected value algorithm may calculate an expected value of an angle parameter for a quantum state.

Alternatively, the predetermined optimization algorithm may calculate an angle for maximizing an expected value of a cost function of the problem.

Alternatively, the method may further include a step of determining one quantum operator index among a plurality of quantum operator index pre-allocated to the problem by using a predetermined quantum operator index algorithm.

Alternatively, the predetermined quantum operator index algorithm may select an index of a quantum operator in which an increase amount of a final cost expected value is largest among the plurality of quantum operator indexes.

Alternatively, the method may further include a step of determining whether optimization is completed based on a predetermined criterion for determining whether the optimization is completed after the optimization step; and a step of iteratively performing, when it is determined that the optimization is not completed, the initialization step, the operating step, the measurement step, the expected value calculation step, and the optimization step by using the second angle parameter instead of the first angle parameter.

Another exemplary embodiment of the present disclosure provides a computer program stored in a non-transitory computer-readable medium, in which the computer program allows a processor of a quantum computing device to perform a method for implementing a quantum approximate optimization algorithm, and the method may include: an initialization step of changing a plurality of qubits initialized into a superposition state by using a Hadamard gate; an operating step of performing an operation for each of the plurality of qubits which is in the superposition state by using a plurality of quantum operators set with a predetermined first angle parameter, wherein the plurality of quantum operators correspond to a cost function of a problem to be solved; a measurement step of acquiring a result value by performing a measurement for the plurality of qubits acquired as an operation performance result; an expected value calculation step of calculating an expected value by inputting the result value into a predetermined expected value algorithm; and an optimization step of calculating a second angle parameter different from a first angle parameter by inputting a predetermined first angle parameter and the expected value into a predetermined optimization algorithm.

Yet another exemplary embodiment of the present disclosure provides a quantum computing device for implementing a quantum approximate optimization algorithm, which may include: a processor; and a memory, in which the processor may perform an initialization operation of changing a plurality of qubits initialized into a superposition state by using a Hadamard gate; an operating operation of performing an operation for each of the plurality of qubits which is in the superposition state by using a plurality of quantum operators set with a predetermined first angle parameter, wherein the plurality of quantum operators correspond to a cost function of a problem to be solved; a measurement operation of acquiring a result value by performing a measurement for the plurality of qubits acquired as an operation performance result; an expected value calculation operation of calculating an expected value by inputting the result value into a predetermined expected value algorithm; and an optimization operation of calculating a second angle parameter different from a first angle parameter by inputting a predetermined first angle parameter and the expected value into a predetermined optimization algorithm.

According to an exemplary embodiment of the present disclosure, there is an effect in that by modifying problem Hamiltonian and mixing Hamiltonian applied at a QAOA iteration step, the number of operations is smaller than that in problem Hamiltonian and mixing Hamiltonian applied at a QAOA iteration step in the related art, so a depth of a circuit becomes smaller.

According to an exemplary embodiment of the present disclosure, there may be an effect that a similar performance as a high step of the QAOA is achieved in addition to the effect in that the number of operations and the depth of the circuit are made to be smaller.

According to an exemplary embodiment of the present disclosure, a quantum algorithm which is more suitable for an NISQ age can be used.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for purposes of explanation, numerous specific details are set forth to provide a comprehensive understanding of one or more aspects. However, it will be apparent that the aspect(s) can be executed without the detailed matters.

FIG. 1 is a block diagram of a quantum computing device for implementing a quantum approximate optimization algorithm according to an exemplary embodiment of the present disclosure.

FIG. 2 is a diagram illustrating a method for implementing a quantum approximate optimization algorithm, which is performed by a quantum computing device according to an exemplary embodiment of the present disclosure.

FIG. 3 is a diagram describing an initialization step performed by the quantum computing device according to an exemplary embodiment of the present disclosure.

FIG. 4 is a diagram describing an operating step performed by the quantum computing device according to an exemplary embodiment of the present disclosure.

FIG. 5 is a diagram illustrating a graph having four nodes and five edges.

FIG. 6 is a diagram illustrating a 1-level QAOA quantum circuit for the graph of FIG. 5, which is performed by the quantum computing device according to an exemplary embodiment of the present disclosure.

FIG. 7 is a diagram illustrating a circuit diagram in which problem Hamiltonian and mixing Hamiltonian operations are performed for the graph of FIG. 5, and an additional operation is performed by selecting specific edges (1,2) and (2,4), which is performed by the quantum computing device according to an exemplary embodiment of the present disclosure.

FIGS. 8A, 8B, 8C and 8D are the result graphs of simulating the existing 1 and 2-level QAOA techniques, and a quantum approximate optimization algorithm technique, which is performed by the quantum computing device according to an exemplary embodiment of the present disclosure for a random graph.

FIG. 9 is a normal schematic diagram of an exemplary computing environment in which the exemplary embodiments of the present disclosure may be implemented.

### DETAILED DESCRIPTION

Various exemplary embodiments will now be described with reference to drawings. In this specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a executed on a processor, the processor, an object, an execution thread, a program, and/or a computer, but is not limited thereto. For example, both an application executed in a computing device and the computing device may be the components. One or more components may reside within the processor and/or an execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

In addition, the term “or” is intended to mean not exclusive “or” but implicit “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other exemplary embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

In addition, in the present disclosure, the term “etc.” such as “A, B, etc.” should be interpreted to mean “a case including only A”, “a case including only B”, and “a case in which A and B are combined”.

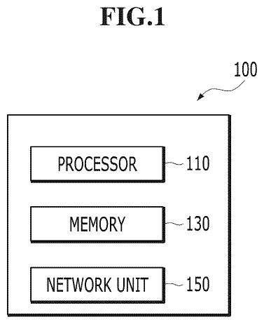

FIG. 1 is a block diagram of a quantum computing device for implementing a quantum approximate optimization algorithm according to an exemplary embodiment of the present disclosure.

A configuration of the quantum computing device illustrated in FIG. 1 is only an example shown through simplification. In an exemplary embodiment of the present disclosure, the quantum computing device may include other components for providing a logical operation, and only some of the disclosed components may also constitute the quantum computing device.

Referring to FIG. 1, the quantum computing device 100 may implement a quantum approximate optimization algorithm. In an exemplary embodiment, the quantum computing device 100 may be a device that uses a qubit. In another exemplary embodiment, the quantum computing device 100 may include a classical computing device that processes bits in addition to the qubit. Accordingly, the quantum computing device 100 as a device including both a quantum computer processing the qubit and a classical computer processing the bit may be a device capable of processing both the qubit and the bit.

The quantum computing device 100 may include a processor 110, a memory 130, and a network unit 150. The processor 110 may be constituted by one or more cores and may include processors for data analysis and quantum processing, which include a central processing unit (CPU), a general purpose graphics processing unit (GPGPU), a tensor processing unit (TPU), and the like of the computing device. The processor 110 may generally control an overall operation of the quantum computing device 100. For example, the processor 110 may process signals, data information, etc., input or output through components included in the quantum computing device 100. As another example, the processor 110 may read a computer program stored in the memory 130 to perform the quantum processing according to an exemplary embodiment of the present disclosure. The processor 110 may perform a calculation by using quantum mechanical physical phenomena such as indexing information expression of quantum superposition and a parallel operation using quantum entanglement.

According to some exemplary embodiments of the present disclosure, the memory 130 may store any type of information generated or determined by the processor 110 or any type of information received by the network unit 150.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The quantum computing device 100 may operate in connection with a web storage performing a storing function of the memory 130 on the Internet. The description of the memory is just an example and the present disclosure is not limited thereto. The network unit 150 according to some exemplary embodiments of the present disclosure may include an arbitrary wired/wireless communication network that may transmit/receive arbitrary type data and signals. The techniques described in this specification may also be used in other networks in addition to the aforementioned networks.

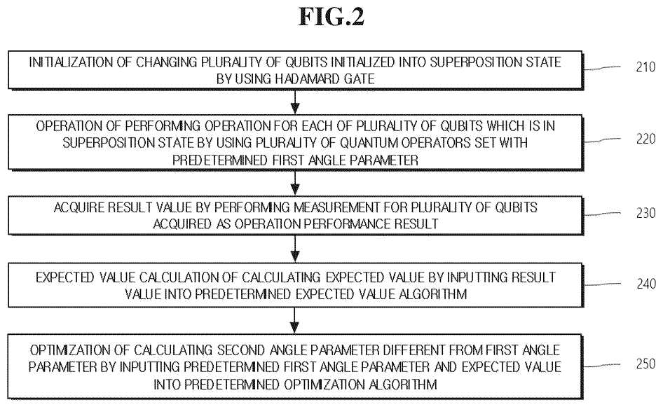

FIG. 2 is a diagram illustrating a method for implementing a quantum approximate optimization algorithm, which is performed by a quantum computing device according to an exemplary embodiment of the present disclosure.

Steps illustrated in FIG. 2 are exemplary steps. Therefore, it will also be apparent to those skilled in the art that some of the steps of FIG. 2 may be omitted or there may be additional steps within a range without departing from a spirit scope of the present disclosure.

Further, specific contents regarding the components (e.g., the quantum computing device 100, etc.) disclosed in FIG. 2 may be replaced with the contents described through FIG. 1 above.

In an additional exemplary embodiment, like a scheme in which some of the steps illustrated in FIG. 2 are performed by the quantum computing device 100 and some other steps are performed by a separate classical computing device different from the quantum computing device 100, the steps in FIG. 2 may also be implemented by a plurality of entities.

In the present disclosure, the quantum circuit may include at least one qubit, at least one quantum gate acting on at least one qubit, and/or a measurement.

In the present disclosure, the qubit (e.g., a physical qubit, a logical qubit, etc.) may be a basic unit of information for processing data using a phenomenon related to quantum mechanics. The qubit may simultaneously express values corresponding to various bits by using the quantum superposition state. For example, the qubit may express respective values as probabilities such as ‘0 with a probability of 20% and 1 with a probability of 80%’. The qubit may be determined as one state while the quantum superposition (entangled) state is released when being measured (observed). For example, the qubit starts in a basis state indicating a state of |0 [symbol] or |1 [symbol] , and may show a state changed by a quantum gate. In addition, the qubit may be determined as the state of |0 [symbol] or |1 [symbol] when being measured (observed). The qubit may be expressed by a 2-dimensional vector.

In the present disclosure, the quantum computing device 100 may initialize the qubit or prepare the qubit in a specific state by using various methods (e.g., using the quantum gate, etc.). In the present disclosure, at least one quantum gate may be an element indicating an operation applied to the qubit in the quantum computer. At least one quantum gate may transform the quantum state of the qubit.

At least one quantum gate may be operated by a matrix multiplication of complex vectors. At least one quantum gate may include a Hadamard gate, a Pauli gate, a Phase shift gate (e.g., an S gate, a T gate, etc.), a CNOT gate, etc.

The Hadamard gate may be a gate that makes the state of the qubit which is the state of |0 [symbol] or |1 [symbol] into a superposition state in which |0 [symbol] and |1 [symbol] are simultaneously present. A logic symbol of the Hadamard gate may be

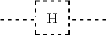

in the quantum circuit. A matrix equation of the Hadamard gate may be

$$\frac{1}{\sqrt{2}} [ \begin{matrix}1 & 1 \\ 1 & - 1\end{matrix} ] .$$

A Hadamard operation H may be an operation that transforms an X basis into a Z basis. Further, the Hadamard operation H may be an operation that transforms the Z basis into the X basis.

The Pauli gate may include a Pauli-X gate, a Pauli-Y gate, and a Pauli-Z gate.

The Pauli-X gate may be a gate that rotates the state of the qubit around an X axis. The Pauli-X gate may perform an operation of inverting the state of the qubit. The Pauli-X gate may correspond to the NOT gate. A logic symbol of the Pauli-X gate may be

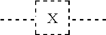

in the quantum circuit. A matrix equation of the Pauli-X gate may be

$$[ \begin{matrix}0 & 1 \\ 1 & 0\end{matrix} ] .$$

The Pauli-Y gate may be a gate that rotates the state of the qubit around a Y axis. The Pauli-Y gate may perform an operation of inverting the state of the qubit, and assigning a negative symbol to a complex coefficient. A logic symbol of the Pauli-Y gate may be

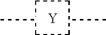

in the quantum circuit. A matrix equation of the Pauli-Y gate may be

$$[ \begin{matrix}0 & - i \\ i & 0\end{matrix} ] .$$

i may be an imaginary unit.

The Pauli-Z gate may be a gate that rotates the state of the qubit around a Z axis. The Pauli-Z gate may perform an operation of changing a symbol of the state with respect to the state of the qubit. A logic symbol of the Pauli-Z gate may be

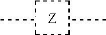

in the quantum circuit. A matrix equation of the Pauli-Z gate may be

$$[ \begin{matrix}1 & 0 \\ 0 & - 1\end{matrix} ] .$$

The Phase shift gate may be a gate that changes a phase of the qubit. The Phase shift gate may include an S gate, a T gate, etc.

The S gate may be a gate that performs an operation of bringing a phase change of 90 degrees to the qubit. A logic symbol of the S gate may be

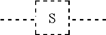

in the quantum circuit. A matrix equation of the S gate may be

$$[ \begin{matrix}1 & 0 \\ 0 & i\end{matrix} ] .$$

i may be the imaginary unit.

The T gate may be a gate that performs an operation of bringing a phase change of 45 degrees to the qubit. A logic symbol of the T gate may be

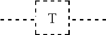

in the quantum circuit. A matrix equation of the T gate may be

$$[ \begin{matrix}1 & 0 \\ 0 & {e}^{i π / 4}\end{matrix} ] .$$

i may be the imaginary unit. e^{iπ/4} as a complex number calculated according to the Euler's formula may be a complex number corresponding to an angle of 45 degrees on a complex plane.

The CNOT gate may be a gate that makes two qubits become to the entangled state.

The CNOT gate may be a gate that performs a NOT gate operation for a second qubit (target qubit) when a first qubit (control qubit) is |1 [symbol] . A logic symbol of the CNOT gate may be

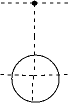

in the quantum circuit. ● may be the control qubit and may be the target qubit. A matrix equation of the CNOT gate may be

$$[ \begin{matrix}1 & 0 & 0 & 0 \\ 0 & 1 & 0 & 0 \\ 0 & 0 & 0 & 1 \\ 0 & 0 & 1 & 0\end{matrix} ] .$$

The measurement may be a process of separating the state of the qubit into one of the basis states, and obtaining a measurement result through the separated state. For example, the processor 110 performs the measurement for the state of the qubit in the X or Z basis state in the quantum circuit to obtain the state of |1 [symbol] or |1 [symbol] . When the measured state of the qubit is the state of |0 [symbol] , the processor 110 may determine the corresponding state as 0 as the classical bit. When the measured state of the qubit is the state of |1 [symbol] , the processor 110 may determine the corresponding state as 1 as the classical bit. A symbol of the measurement in the quantum circuit may be [symbol] .

In the present disclosure, a definition of specific methodologies related to a quantum approximate optimization algorithm (QAOA) is disclosed in a thesis (Farhi, E., Goldstone, J., Gutmann, S., “A Quantum Approximate Optimization Algorithm,” arXiv: 1411.4028, (2014)), and the thesis is incorporated herein by reference.

In the present disclosure, a MAX-CUT problem may be a problem in that a case where the maximum number of cut edges is found when a graph is given. That is, the MAX-CUT problem may be a problem in that a case of a group which maximizes the number of cases of nodes connected to edges of different groups is found when nodes which are present in the graph are classified into two groups.

According to an exemplary embodiment of the present disclosure, the processor 110 of the quantum computing device 100 may perform an initialization step (210) of changing a plurality of qubits initialized into a superposition state by using the Hadamard gate.

The number of plurality of initialized qubits may correspond to a data size of a problem to be solved.

In an exemplary embodiment, the processor 110 may perform an operating step (220) of performing an operation for each of the plurality of qubits which is in the superposition state by using a plurality of quantum operators set with a predetermined first angle parameter.

The plurality of quantum operators may correspond to a cost function of the problem to be solved.

In an exemplary embodiment, the processor 110 may generate qubits which are as large as the nodes of the graph by considering the MAX-CUT problem, and superpose the quantum state by considering the number of cases of all nodes when the nodes are classified into two groups. That is, when the number of nodes is n, |0 [symbol] of n qubits may be prepared. The number of cases of problems having may be expressed by a mode in which when the group is divided into two groups A and B, if the node is included in group A, the node has a value of 0 and if the node is included in group B, the node has a value of 1. In order to express the total number of cases of n nodes which are classified into groups A and B, the quantum state of |0 [symbol] may be expressed by using the Hadamard gate. When the Hadamard gate is computed in the qubit, the quantum state of |0 [symbol] is superposed with a total of 2ⁿ quantum states to express the total number of cases of problems.

The processor 110 may perform a problem Hamiltonian operating step. The problem Hamiltonian operating step may be a step of computing a plurality of quantum operators by transforming the cost function of the problem to the plurality of quantum operators, and adding a predetermined 1-1^{st} angle parameter to the plurality of quantum operators.

In an exemplary embodiment, an operator R_{zz} may be used to reflect a MAX-CUT cost function in the MAX-CUT problem.

In an exemplary embodiment, the problem Hamiltonian may transform the cost function (objective function) of the problem to a form of an operator. The processor 110 may correspond a cost value to a phase and an amplitude in the quantum state by the problem Hamiltonian.

The cost function may be defined differently depending on a problem, and may define data having a largest or lowest cost as a solution of the corresponding problem. For convenience of term description, the cost function in the present disclosure may be defined to find the data having the largest cost.

The processor 110 may perform a mixing Hamiltonian operating step. The mixing Hamiltonian operating step may be a step of performing an operation for an Rₓ operator which rotates the plurality of qubits acquired as an operation result in the problem Hamiltonian operating step based on an X axis by using a predetermined 1-2^{nd} angle parameter iteratively as large as the number of plurality of initialized qubits. The Rₓ operator may include an angle parameter.

The mixing Hamiltonian may serve to solve a problem in that a phase value may not be acquired due to characteristics of the quantum computer which measures at a Z axis. The processor 110 may acquire a quantum state in which a cost is reflected to a probability value of the quantum state from the quantum state transformed by the problem Hamiltonian by using the mixing Hamiltonian.

When the problem Hamiltonian and the mixing Hamiltonian used in the QAOA are applied to an actual quantum circuit, the angle parameter may be considered.

The processor 110 may perform a recursion Hamiltonian operating step. The recursion Hamiltonian operating step may be a step of performing the quantum operation for a predetermined specific operator by using a predetermined 1-3^{rd} angle parameter.

The processor 110 may perform a recursion mixing Hamiltonian operating step. The recursion mixing Hamiltonian operating step may be a step of performing the operation for the Rₓ operator which rotates the plurality of qubits acquired as an operation result in the recursion Hamiltonian operating step based on the X axis by using a predetermined 1-4^{th} angle parameter.

The processor 110 may perform the recursion Hamiltonian operating step and the recursion mixing Hamiltonian operating step iteratively a predetermined number of times (e.g., once, twice, etc.).

The processor 110 may perform a measurement step (230) of acquiring a result value by performing a measurement for the plurality of qubits acquired as an operation performance result.

The processor 110 may acquire a plurality of result values by iterating the initialization step (210), the operating step (220), and the measurement step (230) a predetermined number of iteration times after the measurement step (230).

The processor 110 may perform an expected value calculation step (240) of calculating an expected value by inputting a result value into a predetermined expected value algorithm (e.g., an equation). The predetermined expected value algorithm may be an algorithm of calculating an expected value of an angle parameter for a quantum state.

In an exemplary embodiment, the processor 110 may perform an expected value calculation step of calculating an expected value by inputting a plurality of result values into a predetermined expected value algorithm.

The processor 110 may perform an optimization step (250) of calculating a second angle parameter different from a first angle parameter by inputting a predetermined first angle parameter and the expected value into a predetermined optimization algorithm.

The predetermined optimization algorithm (e.g., equation) may be an algorithm of calculating for an angle for maximizing an expected value of the cost function of the problem. The predetermined optimization algorithm may include a slope based optimization algorithm. However, the type of predetermined optimization algorithm is not limited thereto.

The processor 110 may determine one quantum operator index among a plurality of quantum operator indexes pre-allocated to the problem by using a predetermined quantum operator index algorithm (e.g. equation, etc.).

The predetermined quantum operator index algorithm may be an algorithm of selecting an index of a quantum operator in which an increase amount of a final cost expected value is largest among the plurality of quantum operator indexes.

The increase amount of the expected value (a difference of the expected value) may be defined as in Equation 1 below.

$$Δ C = 〈 {C}^{′} 〉 - 〈 C 〉 = 〈 ψ \vert {U}^{†} ( {H}_{R} , ε ) {U}^{†} ( {H}_{{M}^{′}} , δ ) {H}_{P} U ( {H}_{{M}^{′}} , δ ) U ( {H}_{R} , ε ) \vert ψ 〉 - 〈 ψ \vert {H}_{P} \vert ψ 〉 \qquad [ Equation 1 ]$$

Where |ψ [symbol] may represent a quantum state before the recursion Hamiltonian operation and the recursion mixing Hamiltonian operation are performed, Hₚ may represent a problem Hamiltonian, U(H_{M}, ϵ) may represent a unitary operator that quantumly operates the recursion Hamiltonian, and U (H_{M′}, δ) may represent a unitary operator of quantumly operating recursion mixing Hamiltonian. The processor 110 may set the unitary operator and Hamiltonian used in a specific quantum operator selecting process (a process of determining one quantum operator index among the plurality of quantum operator indexes pre-allocated to the problem) differently depending on a problem to be initially solved and a conditional equation. The processor 110 may select one term in H_{P} and set the one selected term to H_{R}, and may set H_{M′} according to a qubit index operated by H_{R} set at that time.

The processor 110 may determine whether optimization is completed based on a predetermined criterion for determining whether the optimization is completed after the optimization step (250). The predetermined criterion may determine that the optimization is not completed when a second angle parameter is less than a predetermined threshold, for example. However, the predetermined criterion is not limited thereto, and may include various schemes.

When it is determined that the optimization is not completed, the processor 110 may iteratively perform the initialization step, the operating step, the measurement step, the expected value calculation step, and the optimization step by using the second angle parameter instead of the first angle parameter.

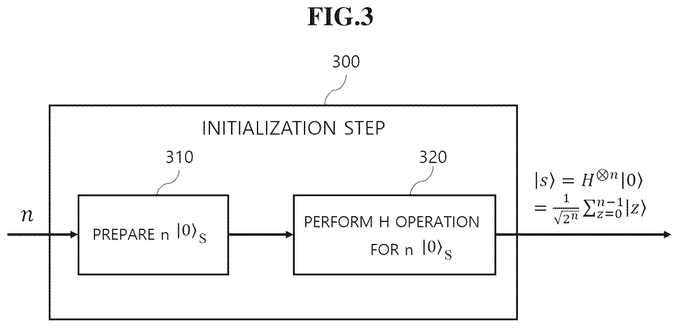

FIG. 3 is a diagram describing an initialization step (300) performed by the quantum computing device according to an exemplary embodiment of the present disclosure.

Referring to FIG. 3, the processor 110 may prepare n |0 [symbol] s based on 2ⁿ which is a total data size of a problem to be solved (310).

The processor 110 may prepare a superposed quantum state |s [symbol] by operating a Hadamard gate H in n |0 [symbol] _{S} (320). The quantum state |s [symbol] superposed with a Hadamard gate operation in |0 [symbol] may be defined as in Equation 2 below.

$$H \vert 0 〉 = \frac{1}{\sqrt{2}} ( \vert 0 〉 + \vert 1 〉 ) , \vert s 〉 = {H}^{⊗ n} \vert 0 〉 = \frac{1}{\sqrt{{2}^{n}}} {{\sum }_{z = 0}}^{n - 1} \vert z 〉 \qquad [ Equation 2 ]$$

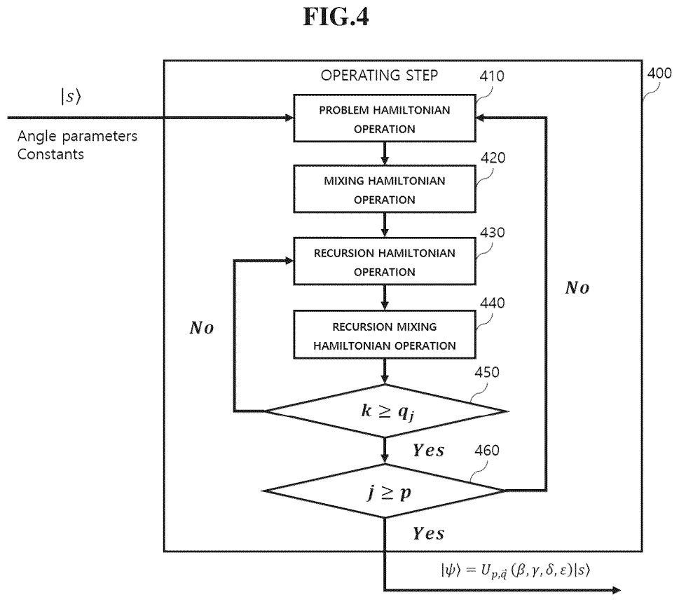

FIG. 4 is a diagram describing an operating step performed by the quantum computing device according to an exemplary embodiment of the present disclosure.

Referring to FIG. 4, the processor 110 may consider the conditional equation of the problem to be solved in the operating step (400), the predetermined angle parameter (e.g., the first angle parameter, etc.) and the quantum state |s [symbol] generated in the initialization step as inputs. A condition of a problem in the MAX-CUT problem may mean a graph state (a connection state of the node and the edge).

The processor 110 may sequentially perform a problem Hamiltonian operation (410), a mixing Hamiltonian operation (420), a recursion Hamiltonian operation (430), and a recursion mixing Hamiltonian (440) in the quantum state generated in the initialization step.

The processor 110 may iterate an operation for the number of operation times of (\vec{g}, p) which is an operation iteration condition in the operating step (400) (No in 450). \vec{q}=(q₁, q₂, . . . , qₚ) may mean the number of iteration times of the recursion Hamiltonian operation and the recursion mixing Hamiltonian operation. In FIG. 4, k may represent the number of times at which the recursion Hamiltonian operation and the recursion mixing Hamiltonian operation are iteratively performed in a j level.

The processor 110 may terminate iteratively performing the recursion Hamiltonian operation and the recursion mixing Hamiltonian operation at a time k and qⱼ are equal to each other (Yes in 450).

The processor 110 may iterate the problem Hamiltonian operation (410), the mixing Hamiltonian operation (420), the recursion Hamiltonian operation (430), and the recursion mixing Hamiltonian (440) (No in 460), p may mean the total number of iteration times of the operation performed in the operating step (400). In FIG. 4, j may mean the number of times at which all operations are iteratively performed while all p-level operations are performed.

The processor 110 may terminate the operation step (400) at a time when j and p become equal to each other (Yes in 460), and finally output a finally operated quantum state |ψ>. The finally operated quantum state |ψ> may be defined as in Equation 3 below.

$$\vert ψ 〉 = {U}_{p \cdot \vec{g}} ( β , γ , δ , ε ) \vert s 〉 = {{\prod }_{j = p}}^{1} [ {{\prod }_{k = {q}_{j}}}^{1} e \text{?} e \text{?} ] e \text{?} e \text{?} \qquad [ Equation 3 ]$$

$$\text{?} \text{indicates text missing or illegible when filed}$$

In Equation 3, β, γ, ε may mean angle parameters, and H_{P}, H_{M}, H_{R}, H_{RM} may mean problem Hamiltonian, mixing Hamiltonian, recursion Hamiltonian, and recursion mixing Hamiltonian, respectively. All Hamiltonians may vary depending on a problem to be solved, and the recursion Hamiltonian and the recursion mixing Hamiltonian may vary depending on an optimization result. The problem Hamiltonian in the MAX-CUT problem may be defined as in Equation 4 below.

$${H}_{P} = {\sum }_{( u , υ ) ∈ E} \frac{1}{2} ( I - {Z}_{u} {Z}_{υ} ) \qquad [ Equation 4 ]$$

In Equation 4, E may mean a connected edge set, I may mean an identity operator, and Z may mean a Pauli Z operator.

In an exemplary embodiment, the recursion Hamiltonian may be embodied by calculating an expected value based on a final result value of the QAOA. The processor 110 may select an operator which may maximize an expected value anticipated when additionally operating a specific operator of the problem Hamiltonian. The processor 110 may configure the recursion Hamiltonian operation (430) only for the selected operator. The processor 110 may configure the recursion mixing Hamiltonian for a specific qubit in which the recursion Hamiltonian operation (430) is performed.

A scheme of obtaining the recursion Hamiltonian for the MAX-CUT problem is described as below. First, when it is assumed that the quantum state of performing the problem Hamiltonian operation and the mixing Hamiltonian operation is |ψ>, a difference in expected value which may be obtained when adding an operation for a specific edge (u, v) may be defined as in Equation 5 below.

$$Δ C = 〈 {C}^{′} 〉 - 〈 C 〉 = {sin}^{2} 2 δ 〈 ψ \vert {Z}_{u} {Z}_{υ} \vert ψ 〉 + sin 4 δ ( sin ε 〈 ψ \vert {X}_{u} \vert ψ 〉 - cos ε 〈 ψ \vert {Y}_{u} {Z}_{υ} \vert ψ 〉 ) + {sin}^{2} δ ( \sum \text{?} 〈 ψ \vert {Z}_{u} Z \text{?} \vert ψ 〉 + \sum \text{?} 〈 ψ \vert Z \text{?} Z \text{?} \vert ψ 〉 ) + \frac{1}{2} sin 2 δ \{ sin ε ( \sum \text{?} 〈 ψ \vert X \text{?} Z \text{?} Z \text{?} \vert ψ 〉 + \sum \text{?} 〈 ψ \vert Z \text{?} Z \text{?} X \text{?} \vert ψ 〉 ) - cos ε ( \sum \text{?} 〈 ψ \vert Y \text{?} Z \text{?} \vert ψ 〉 + \sum \text{?} 〈 ψ \vert Z \text{?} Y \text{?} \vert ψ 〉 ) \} \qquad [ Equation 5 ]$$

$$\text{?} \text{indicates text missing or illegible when filed}$$

In Equation 5, V may represent a node set, Vu may represent a set of nodes adjacent to a node u, Y may represent a Pauli Y operator, X may represent a Pauli X operator, and Z may represent a Pauli Z operator. An edge (u, v) having a largest difference ΔC in expected value is selected, so the recursion Hamiltonian may be defined as in Equation 6 below.

$${H}_{R} = \frac{1}{2} ( I - {Z}_{u} {Z}_{υ} ) \qquad [ Equation 6 ]$$

In Equation 6, H_{R} may represent the recursion Hamiltonian, I may represent the identity operator, and Z may represent the Pauli Z operator.

The recursion mixing Hamiltonian may be defined as in Equation 7 below based on the specific edge (u, v)

$${H}_{RM} = {X}_{u} - {X}_{υ} \qquad [ Equation 7 ]$$

In Equation 7, H_{RM} may represent the recursion Hamiltonian, Xu may represent a Pauli X operator for u, and Xv may represent a Pauli X operator for v.

The processor 110 may continue to add another specific edge by iteratively calculating the expected value difference by using the recursion Hamiltonian and the recursion mixing Hamiltonian.

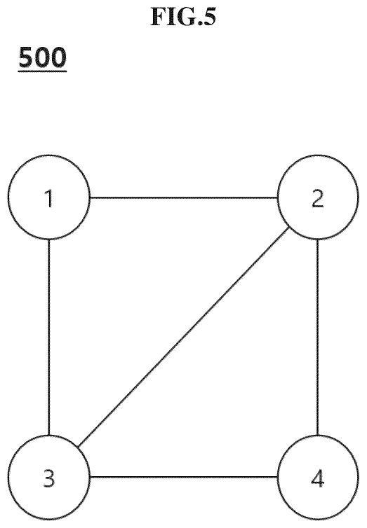

FIG. 5 is a diagram illustrating a graph having four nodes and five edges. Among example problems to which the quantum approximate optimization algorithm may be applied according to an exemplary embodiment of the present disclosure, the MAX-CUT problem may be solved with respect to the graph 500 of FIG. 5.

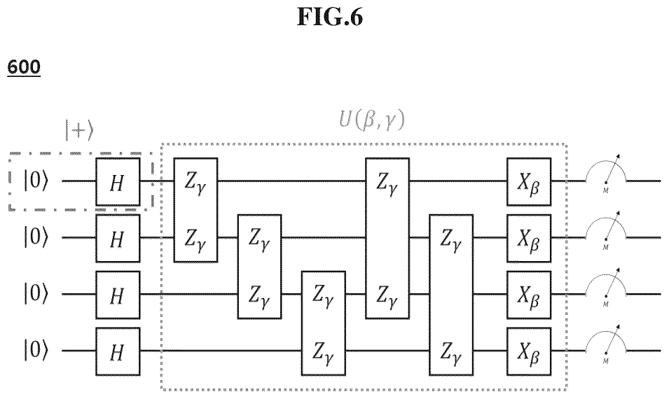

FIG. 6 is a diagram illustrating a 1-level QAOA quantum circuit 600 for the graph of FIG. 5, which is performed by the quantum computing device according to an exemplary embodiment of the present disclosure.

Referring to FIG. 6, the processor 110 may initially prepare a quantum state: |0>, and perform a Hadamard gate operation. When the quantum state is expressed in a vector form, the quantum state may be expressed as

$$\vert 0 〉 = ( \begin{matrix}1 \\ 0\end{matrix} ) and \vert 1 〉 = ( \begin{matrix}0 \\ 1\end{matrix} ) .$$

When the Hadamard gate is expressed
in a matrix form, the Hadamard gate may be expressed as

$$H = \frac{1}{\sqrt{2}} [ \begin{matrix}1 & 1 \\ 1 & - 1\end{matrix} ] .$$

That is, the Hadamard gate operation is performed for |0 [symbol] , which may be expressed as

$$H \vert 0 〉 = \vert + 〉 = \frac{1}{\sqrt{2}} ( \vert 0 〉 + \vert 1 〉 ) .$$

The processor 110 operates a unitary operator which suits to an edge state of the graph in a |+> quantum state. The processor 110 may operate a unitary operator of the problem Hamiltonian with a ZZ operator in the MAX-CUT problem, and referring to the graph of FIG. 5, edges (1,2), (2,3), (3,4), (1,3), (2,4) and (2,4) may be present, and the operation for the unitary operator may be performed in FIG. 6 with respect to the corresponding edges. The ZZ operator may perform the operation for the edges, and performs two nodes included in the corresponding edge through a joint Z operation. An angle parameter used at this time may be set to γ.

The processor 110 may perform an operation for a unitary operator of the mixing Hamiltonian. The processor 110 may perform the operation for the unitary operator of the mixing Hamiltonian with an X operator, and perform the operation for the X operator with respect to all qubits. An angle parameter used at this time may be set to β.

Finally, the processor 110 may perform an optimization process by calculating an expected value with a result value obtained through measurement of the quantum state at an end of the quantum circuit of the 1-level QAOA.

In the present disclosure, a p-level QAOA may be defined as a quantum circuit operation in which the number of times at which the problem Hamiltonian operation is applied is p. That is, the 1-level QAOA may mean that an iteration stage is stage 0, and may mean that the problem Hamiltonian operation is performed once in total.

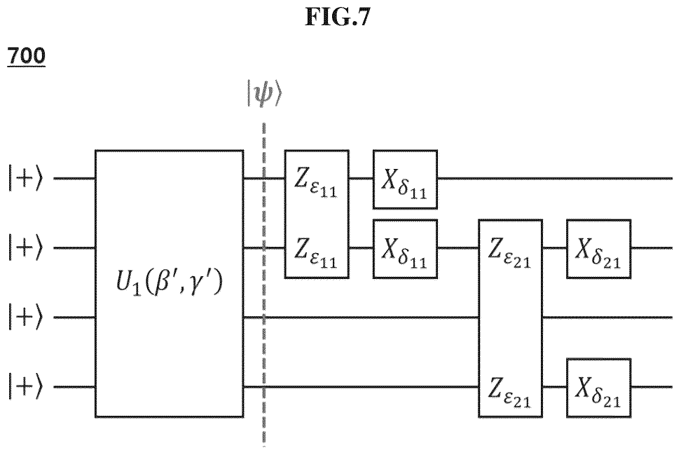

FIG. 7 is a diagram illustrating a circuit diagram 700 in which problem Hamiltonian and mixing Hamiltonian operations are performed for the graph of FIG. 5, and an additional operation is performed by selecting specific edges (1,2) and (2,4), which is performed by the quantum computing device according to an exemplary embodiment of the present disclosure.

The processor 110 may select an edge which maximizes ΔC (through a specific quantum operator selecting process. In the circuit of FIG. 7, the operation is performed by arbitrarily assuming specific edges (1,2) and (2,4).

The circuit diagram of FIG. 7 is designed through the following process. First, the processor 110 may perform the problem Hamiltonian and mixing Hamiltonian operations (β, γ) once after initializing the quantum state, and optimize angle parameters (β, γ) based on result values obtained by measuring the quantum state.

The processor 110 may iteratively perform the quantum state initialization and operation, and the measurement process in the optimization process. The processor 110 may perform the specific quantum operator selecting process based on optimized (β*, γ*). A specific edge (1,2) may be initially selected by the specific quantum operator selecting process, and a specific quantum operator index set {(1,2)} is generated to perform a new quantum state initializing process. The problem Hamiltonian and mixing Hamiltonian operations (β*, γ*) may be performed once in the initialized quantum state, the recursion Hamiltonian and recursion mixing Hamiltonian operations (δ₁₁, ε₁₁) for a specific edge (1,2) may be performed once, and angle parameters (β, γ, δ₁₁, ε₁₁) may be optimized based on result values obtained by measuring the quantum state. Similarly as mentioned above, the processor 110 may iterate the quantum state initializing and the operation, and the measurement process in the optimization process. The processor 110 performs the specific quantum operator selecting process based on the optimized (β*, γ*, δ₁₁*, ε₁₁*). The processor 110 selects a specific edge (2,4) by the specific quantum operator selecting process, and generates a specific quantum operator index set {(1,2), (2,4)} to perform the quantum state initializing process. FIG. 7 may be a circuit diagram in which the problem Hamiltonian and mixing Hamiltonian operations (β, γ) may be performed once in the initialized quantum state, the recursion Hamiltonian and recursion mixing Hamiltonian operations (δ₁₁, ε₁₁) for a specific edge (1,2) may be performed once, and recursion Hamiltonian and recursion mixing Hamiltonian operations for a specific edge (2,4) are performed once.

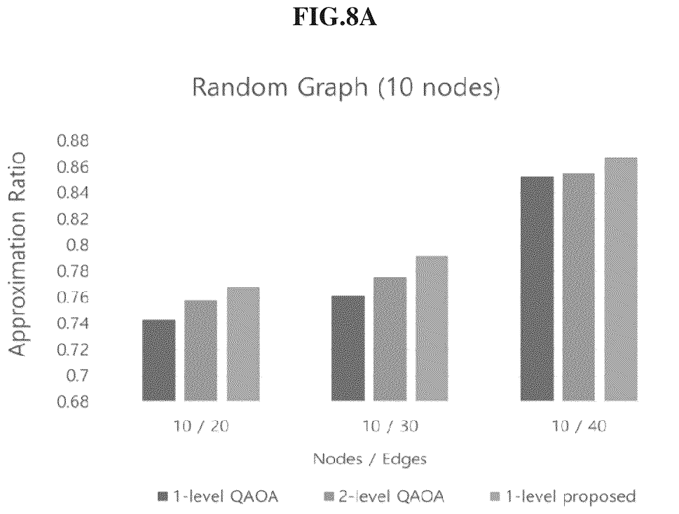

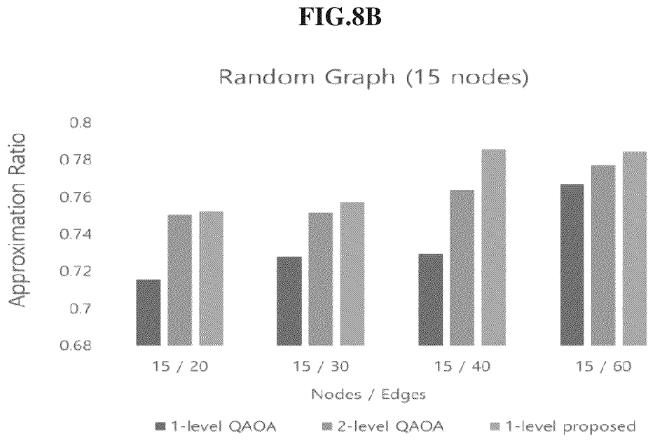

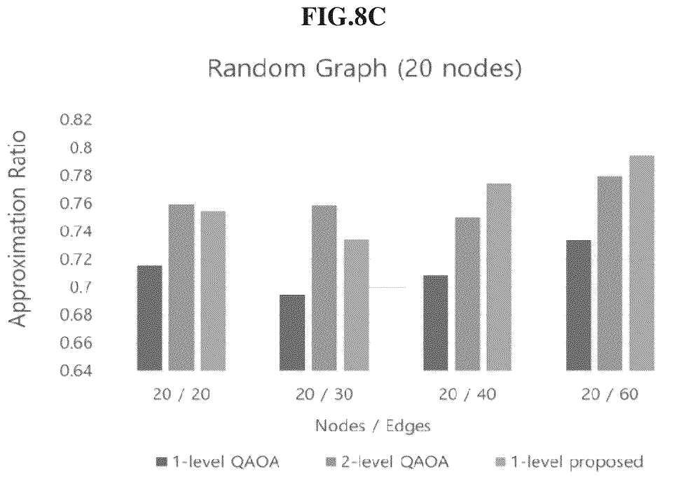

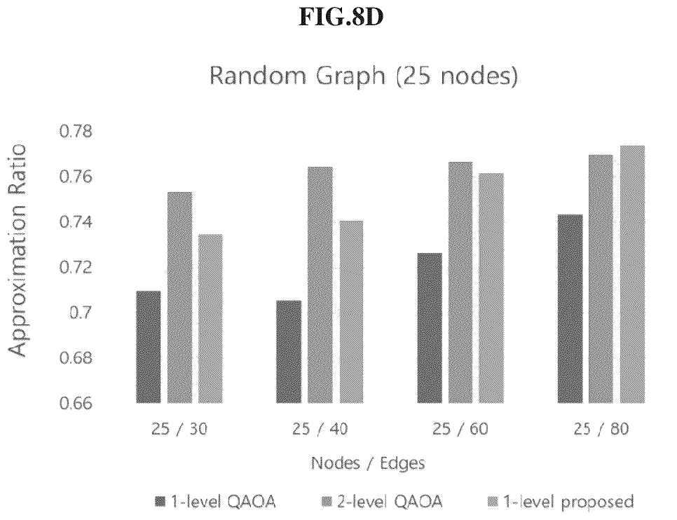

FIGS. 8A, 8B, 8C and 8D are the result graphs of simulating the existing 1 and 2-level QAOA techniques, and a quantum approximate optimization algorithm technique, which is performed by the quantum computing device according to an exemplary embodiment of the present disclosure for a random graph.

In all graphs, a simulation was performed by using an IBM qiskit program, and the simulation was performed by generating 50 different random graph models.

FIG. 8A is a result graph of simulating each of the numbers of edges of 20, 30, and 40 when the number of nodes is 10 in the random graph model. A horizontal axis indicates the numbers of nodes and edges, and a vertical axis is a value that indicates a performance of an algorithm with an approximate ratio. The approximate ratio may be defined as in Equation 8 below.

$$R = \frac{〈 C 〉}{{C}_{max}} \qquad [ Equation 8 ]$$

Where Cₘₐₓ as a maximum value of an expected value may be a value determined when the graph is determined. In FIG. 8A, a proposed method has a higher performance than the 1 and 2-level QAOA techniques. The proposed method (the quantum approximate optimization algorithm according to an exemplary embodiment of the present disclosure) has an even lower quantum circuit complexity than the 2-level QAOA, so a performance similar to or higher than 2-level are significantly advantageous in terms of the complexity.

FIGS. 8B, 8C, and 8D illustrate results of simulating the random graph when the numbers of nodes are 15, 20, and 25, respectively. In second and third drawings having the numbers of nodes of 15 and 20, respectively, the simulation was performed separately for each of 20, 30, 40, and 60 edges. In the case of the fourth drawing in which the number of nodes is 25, the simulation was performed separately for each of 30, 40, 60, and 80 edges. Finally, it may be confirmed that the proposed method (the quantum approximate optimization algorithm according to an exemplary embodiment of the present disclosure) is a method that may have a low complexity and show a high performance.

Table 1 below shows values acquired by calculating a quantum circuit complexity of the proposed method (the quantum approximate optimization algorithm according to an exemplary embodiment of the present disclosure) with respect to the simulation of FIGS. 8A, 8B, 8C and 8D.

TABLE 1

| | Edges | | | | |
|---|---|---|---|---|---|
| Nodes | 20 | 30 | 40 | 60 | 80 |
| 10 | 1.06 | 1.083 | 1.044 | — | — |
| 15 | 1.042 | 1.088 | 1.045 | 1.107 | — |
| 20 | 1.042 | 1.104 | 1.045 | 1.035 | — |
| 25 | — | 1.127 | 1.152 | 1.107 | 1.092 |

In Table 1, except for a quantum circuit complexity generated in the initialization process, the quantum circuit complexity is calculated by assuming that an operation complexity of the 1-level QAOA generated in the operating step is 1. That is, in the case of a graph in which the number of nodes is 10 and the number of edges is 20, the proposed technique has an operation complexity of 1.06, and this is a graph more complex than the 1-level QAOA by 6%. Here, the 2-level QAOA has an operation complexity of 2.

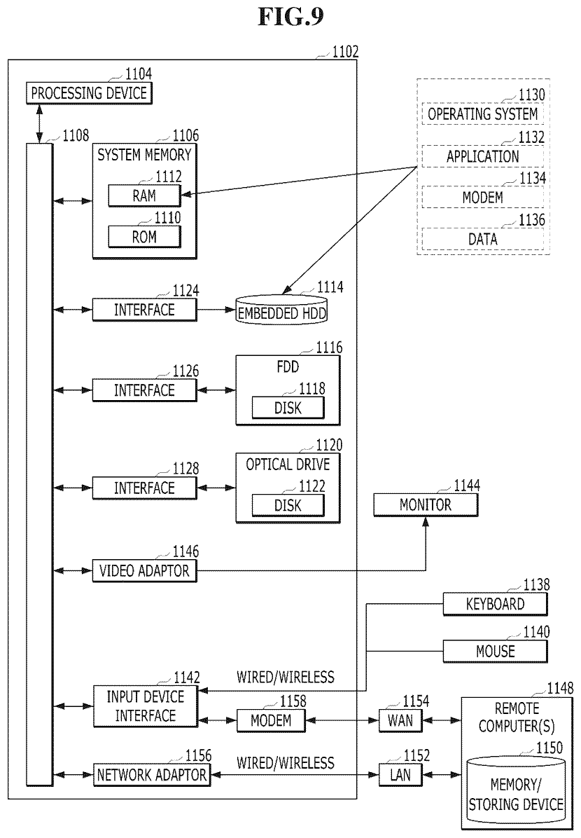

FIG. 9 is a normal schematic diagram of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for implementing a quantum approximate optimization algorithm, which is performed by a processor of a quantum computing device, the method comprising:
an initialization step of changing a plurality of qubits initialized into a superposition state by using a Hadamard gate;
an operating step of performing an operation for each of the plurality of qubits which is in the superposition state by using a plurality of quantum operators set with a predetermined first angle parameter, wherein the plurality of quantum operators correspond to a cost function of a problem to be solved;
a measurement step of acquiring a result value by performing a measurement for the plurality of qubits acquired as an operation performance result;
an expected value calculation step of calculating an expected value by inputting the result value into a predetermined expected value algorithm; and
an optimization step of calculating a second angle parameter different from a first angle parameter by inputting a predetermined first angle parameter and the expected value into a predetermined optimization algorithm.

2. The method of claim 1, wherein the number of plurality of initialized qubits corresponds to a data size of the problem to be solved.

3. The method of claim 1, wherein the operating step includes
a problem Hamiltonian operating step of computing a plurality of quantum operators by transforming the cost function of the problem to the plurality of quantum operators, and adding a predetermined 1-1^{st} angle parameter to the plurality of quantum operators,
a mixing Hamiltonian operating step of iteratively performing an operation for an Rₓ operator which rotates the plurality of qubits acquired as an operation result in the problem Hamiltonian operating step based on an X axis as large as the number of plurality of initialized qubits by using a predetermined 1-2^{nd} angle parameter,
a recursion Hamiltonian operating step of performing the quantum operation for a predetermined specific operator by using a predetermined 1-3rd angle parameter, and
a recursion mixing Hamiltonian operating step of performing an operation for an Rₓ operator which rotates the plurality of qubits acquired as an operation result in the recursion Hamiltonian operating step based on the X axis by using a predetermined 1-4^{th} angle parameter.

4. The method of claim 3, further comprising:
iteratively performing the recursion Hamiltonian operating step and the recursion mixing Hamiltonian operating step a predetermined number of times.

5. The method of claim 1, further comprising:
a step of acquiring a plurality of result values by iterating the initialization step, the operating step, and the measurement step a predetermined number of iteration times after the measurement step,
wherein the expected value calculation step includes
an expected value calculation step of calculating the expected value by inputting the plurality of result values into the predetermined expected value algorithm.

6. The method of claim 1, wherein the predetermined expected value algorithm calculates an expected value of an angle parameter for a quantum state.

7. The method of claim 1, wherein the predetermined optimization algorithm calculates an angle for maximizing an expected value of a cost function of the problem.

8. The method of claim 1, further comprising:
a step of determining one quantum operator index among a plurality of quantum operator index pre-allocated to the problem by using a predetermined quantum operator index algorithm.

9. The method of claim 8, wherein the predetermined quantum operator index algorithm selects an index of a quantum operator in which an increase amount of a final cost expected value is largest among the plurality of quantum operator indexes.

10. The method of claim 1, further comprising:
a step of determining whether optimization is completed based on a predetermined criterion for determining whether the optimization is completed after the optimization step; and
a step of iteratively performing, when it is determined that the optimization is not completed, the initialization step, the operating step, the measurement step, the expected value calculation step, and the optimization step by using the second angle parameter instead of the first angle parameter.

11. A computer program stored in a non-transitory computer-readable medium, wherein the computer program allows a processor of a quantum computing device to perform a method for implementing a quantum approximate optimization algorithm, the method comprising:
an initialization step of changing a plurality of qubits initialized into a superposition state by using a Hadamard gate;
an operating step of performing an operation for each of the plurality of qubits which is in the superposition state by using a plurality of quantum operators set with a predetermined first angle parameter, wherein the plurality of quantum operators correspond to a cost function of a problem to be solved;
a measurement step of acquiring a result value by performing a measurement for the plurality of qubits acquired as an operation performance result;
an expected value calculation step of calculating an expected value by inputting the result value into a predetermined expected value algorithm; and
an optimization step of calculating a second angle parameter different from a first angle parameter by inputting a predetermined first angle parameter and the expected value into a predetermined optimization algorithm.

12. A quantum computing device for implementing a quantum approximate optimization algorithm, comprising:
a processor; and
a memory,
wherein the processor performs:
an initialization operation of changing a plurality of qubits initialized into a superposition state by using a Hadamard gate;
an operating operation of performing an operation for each of the plurality of qubits which is in the superposition state by using a plurality of quantum operators set with a predetermined first angle parameter, wherein the plurality of quantum operators correspond to a cost function of a problem to be solved;
a measurement operation of acquiring a result value by performing a measurement for the plurality of qubits acquired as an operation performance result;
an expected value calculation operation of calculating an expected value by inputting the result value into a predetermined expected value algorithm; and
an optimization operation of calculating a second angle parameter different from a first angle parameter by inputting a predetermined first angle parameter and the expected value into a predetermined optimization algorithm.
